(19) United States
(12) Patent Application Publication
(10) Pub. No.: US 2025/0244758 A1
(43) Pub. Date: Jul. 31, 2025

(54) SYSTEM AND METHOD FOR PROCESSING SOUND DATA

(71) Applicant: The Boeing Company, Arlington, VA (US)

(72) Inventors: Trevor Bergstrom, Palo Alto, CA (US); Melanie K. Lorang, Huntington Beach, CA (US); Brian W. Pontrello, Shoreline, WA (US)

(73) Assignee: The Boeing Company, Arlington, VA (US)

(21) Appl. No.: 18/428,546

(22) Filed: Jan. 31, 2024

(51) Int. Cl. G05B 23/02; G06N 20/00

(52) U.S. Cl. CPC G05B 23/0283; G06N 20/00

(57) ABSTRACT

A method of processing sound data includes receiving the sound data representing a noise generated by at least one component during operation. A sound signature is identified for the at least one component from the sound data. The sound signature includes at least one of a sound type or a frequency range for the noise. The sound signature is classified for the at least one component with a machine learning model to predict a remaining operating life for the at least one component. An operating status of the at least one component is determined based on the remaining operating life predicted.

### FIELD

The present disclosure relates to a system and a method for processing sound data, and in particular, processing sound data to determine an operating status of a component through the use of machine learning.

### BACKGROUND

Machine learning is a process that analyzes data to determine a model that maps input data to output data. One type of machine learning is supervised learning in which a model is trained with a dataset including known output data for a sufficient amount of input data. Once a model is trained, it may be deployed, i.e., applied to new input data to predict the expected output.

Machine learning may be applied to regression problems (where the output data are numeric, e.g., a voltage, a pressure, a number of cycles, etc.) and to classification problems (where the output data are labels, classes, and/or categories, e.g., pass-fail, failure type, etc.). For both types of problems, a broad array of machine learning algorithms are available, with new algorithms the subject of active research. However, selecting training datasets and the quality of the data in the training dataset can greatly influence the ability of the model to predict the expected output from a new dataset.

### DESCRIPTION OF THE DRAWINGS

Some embodiments of the present disclosure are now described, by way of example only, and with reference to the accompanying drawings. The same reference number represents the same element or the same type of element on the drawings.

FIG. 1 illustrates an example camera system and microphone system for capturing image data and sound data of a system on an aircraft.

FIG. 2 illustrates an example method of processing sound data with the system of FIG. 1.

### SUMMARY

A method of processing sound data is disclosed herein. The method includes receiving the sound data representing a noise generated by at least one component during operation. A sound signature is identified for the at least one component from the sound data. The sound signature includes at least one of a sound type or a frequency range for the noise. The sound signature is classified for the at least one component with a machine learning model to predict a remaining operating life for the at least one component. An operating status of the at least one component is determined based on the remaining operating life predicted.

In one or more embodiments of the method, the noise generated by the at least one component captured by the sound data includes sound waves in an ultrasonic frequency range.

In one or more embodiments of the method, the sound data is collected from a microphone system having microphones positioned in predetermined relative locations.

In one or more embodiments of the method, a location of origin of the sound signature is determined relative to the microphone system.

In one or more embodiments of the method, image data is received from a camera system and identifying the location of origin of the sound signature on an image from the image data.

In one or more embodiments of the method, the location of origin of the sound signature is determined based on a triangulation of the sound signature received by the microphones.

In one or more embodiments of the method, the machine learning model is trained with a machine learning algorithm on at least one training dataset, the at least one training dataset includes a collection of sample sound signatures for each of a multitude of sample components.

In one or more embodiments of the method, the sample components are identical to the at least one component.

In one or more embodiments of the method, the at least one training dataset includes a service history for each of the sample components associated with a time when each of the sample sound signatures were obtained.

In one or more embodiments of the method, the collection of sample sound signatures includes at least one of a sound type or a frequency range for each of the sample components.

In one or more embodiments of the method, the at least one component includes multiple components, and the sound data includes multiple noises generated by a corresponding one of the components.

A non-transitory computer-readable medium embodying programmed instructions which, when executed by a processor, are operable for performing a method is disclosed herein. The method includes receiving the sound data representing a noise generated by at least one component during operation. A sound signature is identified for the at least one component from the sound data. The sound signature includes at least one of a sound type or a frequency range for the noise. The sound signature is classified for the at least one component with a machine learning model to predict a remaining operating life for the at least one component. An operating status of the at least one component is determined based on the remaining operating life predicted.

In one or more embodiments of the medium, the noise generated by the at least one component captured by the sound data includes sound waves in an ultrasonic frequency range.

In one or more embodiments of the medium, the sound data is collected from a microphone system having microphones positioned in predetermined relative locations.

In one or more embodiments of the medium, a location of origin of the sound signature relative to the microphone system is determined.

In one or more embodiments of the medium, the machine learning model is trained with a machine learning algorithm on at least one training dataset, the at least one training dataset includes a collection of sample sound signatures for each of a multitude of sample components.

In one or more embodiments of the medium, the at least one training dataset includes a service history for each of the sample components associated with a time when each of the sample sound signatures were obtained.

A system for processing sound data is disclosed herein. The system includes microphones and a controller in electrical communication with the microphones. The controller is configured to receive the sound data that represents a noise generated by at least one component during operation and identify a sound signature for the at least one component from the sound data. The sound signature includes at least one of a sound type or a frequency range for the noise. The controller can also classify the sound signature for the at least one component with a machine learning model to predict a remaining operating life for the at least one component. The controller can then determine an operating status of the at least one component based on the remaining operating life predicted.

In one or more embodiment of the system, the noise generated by the at least one component captured by the sound data includes sound waves in an ultrasonic frequency range.

In one or more embodiment of the system, the machine learning model is trained with a machine learning algorithm on at least one training dataset, the at least one training dataset includes a collection of sample sound signatures for each of a multitude of sample components and the at least one training dataset includes a service history for each of the sample components associated with a time when the sample sound signature was obtained for each of the sample components.

### DESCRIPTION

The Figures and the following description illustrate specific exemplary embodiments of the disclosure. A person of ordinary skill in the art will be able to devise various arrangements that, although not explicitly described or shown herein, embody the principles of the disclosure and are included within the scope of the disclosure. Furthermore, any examples described herein are intended to aid in understanding the principles of the disclosure and are to be construed as being without limitation to such specifically recited examples and conditions. As a result, the disclosure is not limited to the specific embodiments or examples described below, but by the claims and their equivalents.

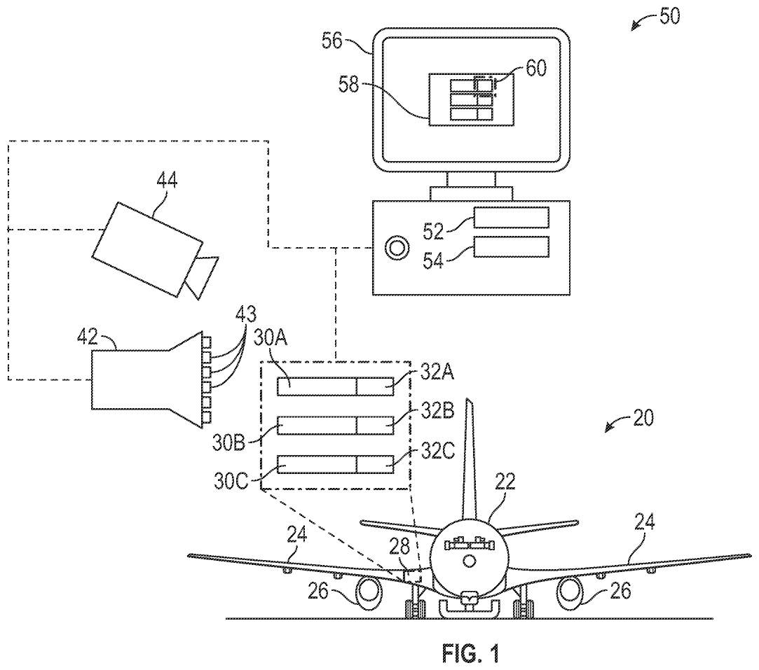

FIG. 1 illustrates an example aircraft 20 comprised of a fuselage 22, a pair of wings 24 extending from opposite sides of the fuselage 22, and a pair of engines 26 supported by a corresponding one of the wings 24. The aircraft 20 is comprised of a multitude of different systems that each include components that are capable of generating noises during operation in both an audible frequency range and an ultrasonic frequency range (i.e. greater than 20 kHz). In the illustrated example, a system 28 includes pumps 30A, 30B, and 30C being driven by electric motors 32A, 32B, and 32C, respectively. While the illustrated system 28 includes pumps 30 and electric motors 32 being used in an aerospace field, this disclosure applies to other systems as well with components capable of generating noise, such as systems in an industrial field, an automotive field, or a maritime field. The maritime field can include implementations for systems for either boats or submarines.

In the illustrated example shown in FIG. 1, a microphone system 42 and a camera system 44 are in communication with a computer system 50. The microphone system 42 and the camera system 44 can be in a direct electrical communication with the computer system 50 or connected through a network or internet connection. The microphone system 42 includes a multitude of microphones 43 fixed relative to a housing. The microphone system 42 can capture the sound waves generated by any of the components in the system 28 and convert them to sound data. In one example, the sound data includes digitally encoded signals that represent the sounds waves.

The camera system 44 includes at least one camera. The camera system 44 can capture images of the components in the system 28. The camera system 44 can capture images in at least one of the visible light spectrum or the infrared light spectrum depending on the operating environment of the system 28.

While the computer system 50 of FIG. 1 is depicted as a unitary computer module for illustrative simplicity, the computer system 50 can be physically embodied as one or more processing nodes having a non-transitory computer-readable storage medium 54, i.e., application-sufficient memory, and associated hardware and software, such as but not limited to a high-speed clock, timer, input/output circuitry, buffer circuitry, and the like. The computer-readable storage medium 54 may include enough read only memory, for instance magnetic or optical memory. Computer-readable code or instructions embodying the methods described below may be executed during operation of the computer system 50 or on a controller. To that end, the computer system 50 may encompass one or more processors 52, e.g., logic circuits, application-specific integrated circuits (ASICs), central processing units, microprocessors, and/or other requisite hardware as needed to provide the programmed functionality described herein. A display screen 56 may be connected to or in communication with the computer readable medium 54 and processor(s) 52 to facilitate a graphical interface for a user implementing this disclosure as set forth below.

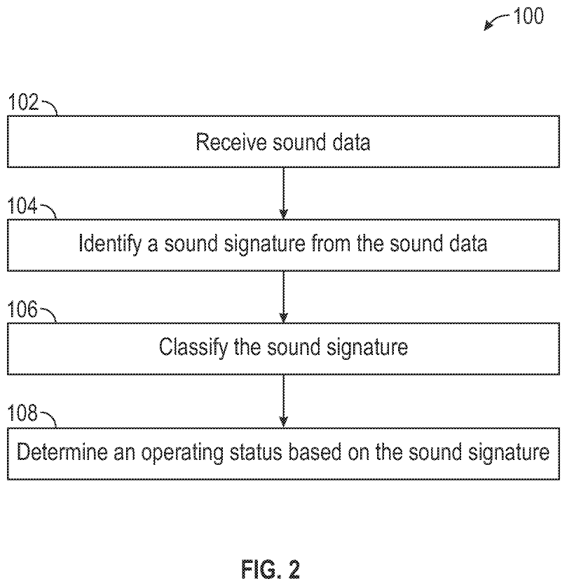

FIG. 2 illustrates a flowchart of a method 100 of classifying sound data generated by the system 28 (FIG. 1) to determine an operating status of at least one component in the system 28. However, as discussed above, this disclosure applies to other types of systems beyond the use in aerospace.

At Block 102, the method 100 receives sound data representative of sounds waves captured by the microphone system 42. The sound data can be stored on the memory 54 on the computer system 50. In the illustrated example, the sound data includes at least a digital representation of sound wave generated by the system 28, such as sound data from one or more of the pumps 30A, 30B, and 30C or one or more of the electric motors 32A, 32B, and 32C. In one example, the sound data represents ultrasonic sound waves produced by the system 28 and captured by the microphone system 42. The method 100 can also receive image data from the camera system 44 representative of one or more images 58 (FIG. 1) of the system 28. In one example, the images 58 of the system 28 are captured in a timeframe that overlaps with a timeframe that the sound data was captured of the system 28.

While the microphone system 42 and the camera system 44 are in an area surrounding or adjacent to the system 28, the microphone system 42 can also collect sound waves from other components besides those in the system 28. Therefore, the method 100 will need to differentiate or isolate sound waves generated by components of interest within the system 28 as opposed to other systems. Furthermore, while the microphone system 42 and the camera system 44 are illustrated capturing sounds waves and images 58 of a single system 28, respectively, the microphone system 42 and the camera system 44 can capture sound waves and images 58 of multiple systems.

At Block 104, the method 100 identifies or isolates a sound signature f from the sound data that represents each of the components in the system 28 that were operating and generating a noise while the noise data was captured. In one example, identifying the sound signature includes determining a sound type and frequency range generated by the operation of a corresponding one of the components in the system 28.

In another example, the sound type and frequency range for operation of each of the components in the system 28 has been predetermined and identifying the sound signature for a given component includes matching a sound type and frequency range from the sound data with the component that corresponds to those values. For example, each of the pumps 30A, 30B, and 30C can include different outputs or operating requirements that result in different sound types and frequency ranges during operation. The predetermined sound types and frequency ranges for the components can be provided by a component manufacturer or collected through experimental use. Similarly, the motors 32A, 32B, and 32C can include different power outputs and rotational speeds that produce different sound types and frequency operating ranges that can be determined prior to installing the component in the system. Also, the computer system 50 can receive system data describing an operation status of each of the components the system 28 to aid in matching the sound data with specific components.

Furthermore, the method 100 can determine a location of an origin of the sound signature to aid in identifying the sound signature. One feature of determining the location is that if any of the pumps 30A, 30B, and 30C or any of the electric motors 32A, 32B, and 32C have identical sound signatures, the computer system 50 can match the sound signatures with the corresponding component based on location. In particular, the computer system 50 determines the location of the individual components in the system 28 through utilizing the multitude of microphones 43 on the microphone system 42. The multitude of microphones 43 enable the computer system 50 to identify the location of the components based on a relative time of the sound signatures reaching each of the microphones 43. In one example, the origin of the sound signature is located in a three-dimensional space surrounding the system 28. Identifying the origin location in three-dimensional space increases the ability to differentiate sound signatures of adjacent components from each other.

In another example, the location of the origin of the sound signature is identified by highlighting or surrounding the location in a bounding box 60 in the image 58 captured by the camera system 44 as shown in FIG. 1. The computer system 50 associate the location of the noise captured by the microphone system 42 to the image 58 captured by the camera system 44 through determining a relative position between the microphone system 42 and the camera system 44. The computer system 50 can also perform object detection to identify specific objects in the image 58 by associating the location of noise captured in the image 58. For example, the computer system 50 can identify the location of the noise in the image 58 and determine if the location corresponds to a location of an identified object, such as the pumps 30A, 30B, and 30C.

Once the component corresponding to a given sound signature from the sound data has been identified, the method 100 classifies the sound signature for the component to predict an operating life for the component (Block 106). The prediction of the operating life for the component occurs through the use of a machine learning model trained on at least one training dataset. In one example, the at least one training dataset includes a collection of sample sound signatures for each of a plurality of sample components in systems 28 across multiple aircraft 20. The at least one training dataset can also include sound data for other systems with similar components, such as pumps or electric motors like the system 28.

The at least one training dataset also includes a service history for each of the components in the system and the service history is associated with a time of capturing the sound data for each component in the systems. The service history can include a time when any individual elements of the component were serviced relative to a time when the sound data was collected. The service history can also include when the component was replaced relative to the time when the sound data was collected. Furthermore, the service history can include a value or estimate representing the amount of use the component experienced between when the sound data was collected and when the component was replaced or required service. When the data described above is used as a training dataset for training a machine learning algorithm to develop a machine learning model, the machine learning model can classify the sound signature of a given component to predict a remaining operating life for the given component based on the sound signature.

At Block 108, the method 100 determines the operating status of the at least one component based on the remaining operating life predicted for the at least one component. If the remaining operating life predicted is greater than a predetermined length or greater than a predetermined percentage of overall operating life predicted for the given component, the method 100 can determine a satisfactory operating status. The satisfactory operating status for the given component indicates that the component does not require immediate replacement or repair.

Alternatively, if the remaining operating life predicted is less than a predetermined length or less than a predetermined percentage of overall operating life predicted for the given component, the method 100 can issue an alert regarding the operating status. The alert for the given component can indicate that the component could require replacement or repair in the near future.

Additionally, when the method 100 is determining the operating status of the given component, the method 100 can compare an operating life for a new component to new to a sum of a time that the given component has been in operation when the sound data was collected, and the remaining operating life predicted. If the sum is less than a predetermined percentage of the operating life for the component when new or differs by greater than a predetermined number of hours, the method 100 can issue an operating status for the given component to indicate that given component or system requires additional investigation. The additional investigation of operating status can lead to further analysis of the component or system for investigating a root cause for the variation between the two values.

The following Clauses provide example configurations of system and methods for processing sound data with the system and method of FIG. 1 and FIG. 2, respectively.

Clause 1: A method of processing sound data, the method comprising: receiving the sound data, wherein the sound data represents a noise generated by at least one component during operation; identifying a sound signature for the at least one component from the sound data, wherein the sound signature includes at least one of a sound type or a frequency range for the noise; classifying the sound signature for the at least one component with a machine learning model to predict a remaining operating life for the at least one component; and determining an operating status of the at least one component based on the remaining operating life predicted.

Clause 2: The method of clause 1, wherein the noise generated by the at least one component captured by the sound data includes sound waves in an ultrasonic frequency range.

Clause 3: The method of clauses 1-2, wherein the sound data is collected from a microphone system having a plurality of microphones positioned in predetermined relative locations.

Clause 4: The method of clauses 1-3, including determining a location of origin of the sound signature relative to the microphone system.

Clause 5: The method of clauses 1-4, including receiving image data from a camera system and identifying the location of origin of the sound signature on an image from the image data.

Clause 6: The method of clauses 1-5, wherein the location of origin of the sound signature is determined based on a triangulation of the sound signature received by the plurality of microphones.

Clause 7: The method of clauses 1-6, wherein the machine learning model is trained with a machine learning algorithm on at least one training dataset, the at least one training dataset includes a collection of sample sound signatures for each of a plurality of sample components.

Clause 8: The method of clauses 1-7, wherein the plurality of sample components are identical to the at least one component.

Clause 9: The method of clauses 1-8, wherein the at least one training dataset includes a service history for each of the plurality of sample components associated with a time when each of the sample sound signatures were obtained.

Clause 10: The method of clauses 1-9, wherein the collection of sample sound signatures includes at least one of a sound type or a frequency range for each of the plurality of sample components.

Clause 11: The method of clauses 1-10, wherein the at least one component includes a plurality of components and the sound data includes a plurality of noises generated by a corresponding one of the plurality of components.

Clause 12: A non-transitory computer-readable medium embodying programmed instructions which, when executed by a processor, are operable for performing a method comprising: receiving sound data, wherein the sound data represents a noise generated by at least one component during operation; identifying a sound signature for the at least one component from the sound data, wherein the sound signature includes at least one of a sound type or a frequency range for the noise; classifying the sound signature for the at least one component with a machine learning model to predict a remaining operating life for the at least one component; and determining an operating status of the at least one component based on the remaining operating life predicted.

Clause 13: The non-transitory computer-readable medium of clause 12, wherein the noise generated by the at least one component captured by the sound data includes sound waves in an ultrasonic frequency range.

Clause 14: The non-transitory computer-readable medium of clauses 12-13, wherein the sound data is collected from a microphone system having a plurality of microphones positioned in predetermined relative locations.

Clause 15: The non-transitory computer-readable medium of clauses 12-14, including determining a location of origin of the sound signature relative to the microphone system.

Clause 16: The non-transitory computer-readable medium of clauses 12-15, wherein the machine learning model is trained with a machine learning algorithm on at least one training dataset, the at least one training dataset includes a collection of sample sound signatures for each of a plurality of sample components.

Clause 17: The non-transitory computer-readable medium of clauses 12-16, wherein the at least one training dataset includes a service history for each of the plurality of sample components associated with a time when each of the sample sound signatures were obtained.

Clause 18: A system for processing sound data, the system comprising: a plurality of microphones; a controller in electrical communication with the plurality of microphones, wherein the controller is configured to: receive the sound data, wherein the sound data represents a noise generated by at least one component during operation; identify a sound signature for the at least one component from the sound data, wherein the sound signature includes at least one of a sound type or a frequency range for the noise; classify the sound signature for the at least one component with a machine learning model to predict a remaining operating life for the at least one component; and determine an operating status of the at least one component based on the remaining operating life predicted.

Clause 19: The system of clause 18, wherein the noise generated by the at least one component captured by the sound data includes sound waves in an ultrasonic frequency range.

Clause 20: The system of clauses 18-19, wherein the machine learning model is trained with a machine learning algorithm on at least one training dataset, the at least one training dataset includes a collection of sample sound signatures for each of a plurality of sample components and the at least one training dataset includes a service history for each of the plurality of sample components associated with a time when the sample sound signature was obtained for each of the plurality of sample components.

While various embodiments have been described, the description is intended to be exemplary rather than limiting. It will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method of processing sound data, the method comprising:
receiving the sound data, wherein the sound data represents a noise generated by at least one component during operation;
identifying a sound signature for the at least one component from the sound data, wherein the sound signature includes at least one of a sound type or a frequency range for the noise;
classifying the sound signature for the at least one component with a machine learning model to predict a remaining operating life for the at least one component; and
determining an operating status of the at least one component based on the remaining operating life predicted.

2. The method of claim 1, wherein the noise generated by the at least one component captured by the sound data includes sound waves in an ultrasonic frequency range.

3. The method of claim 1, wherein the sound data is collected from a microphone system having a plurality of microphones positioned in predetermined relative locations.

4. The method of claim 3, including determining a location of origin of the sound signature relative to the microphone system.

5. The method of claim 4, including receiving image data from a camera system and identifying the location of origin of the sound signature on an image from the image data.

6. The method of claim 4, wherein the location of origin of the sound signature is determined based on a triangulation of the sound signature received by the plurality of microphones.

7. The method of claim 1, wherein the machine learning model is trained with a machine learning algorithm on at least one training dataset, the at least one training dataset includes a collection of sample sound signatures for each of a plurality of sample components.

8. The method of claim 7, wherein the plurality of sample components are identical to the at least one component.

9. The method of claim 7, wherein the at least one training dataset includes a service history for each of the plurality of sample components associated with a time when each of the sample sound signatures were obtained.

10. The method of claim 7, wherein the collection of sample sound signatures includes at least one of a sound type or a frequency range for each of the plurality of sample components.

11. The method of claim 1, wherein the at least one component includes a plurality of components and the sound data includes a plurality of noises generated by a corresponding one of the plurality of components.

12. A non-transitory computer-readable medium embodying programmed instructions which, when executed by a processor, are operable for performing a method comprising:
receiving sound data, wherein the sound data represents a noise generated by at least one component during operation;
identifying a sound signature for the at least one component from the sound data, wherein the sound signature includes at least one of a sound type or a frequency range for the noise;
classifying the sound signature for the at least one component with a machine learning model to predict a remaining operating life for the at least one component; and
determining an operating status of the at least one component based on the remaining operating life predicted.

13. The non-transitory computer-readable medium of claim 12, wherein the noise generated by the at least one component captured by the sound data includes sound waves in an ultrasonic frequency range.

14. The non-transitory computer-readable medium of claim 12, wherein the sound data is collected from a microphone system having a plurality of microphones positioned in predetermined relative locations.

15. The non-transitory computer-readable medium of claim 14, including determining a location of origin of the sound signature relative to the microphone system.

16. The non-transitory computer-readable medium of claim 12, wherein the machine learning model is trained with a machine learning algorithm on at least one training dataset, the at least one training dataset includes a collection of sample sound signatures for each of a plurality of sample components.

17. The non-transitory computer-readable medium of claim 16, wherein the at least one training dataset includes a service history for each of the plurality of sample components associated with a time when each of the sample sound signatures were obtained.

18. A system for processing sound data, the system comprising:
a plurality of microphones;
a controller in electrical communication with the plurality of microphones, wherein the controller is configured to:
receive the sound data, wherein the sound data represents a noise generated by at least one component during operation;
identify a sound signature for the at least one component from the sound data, wherein the sound signature includes at least one of a sound type or a frequency range for the noise;
classify the sound signature for the at least one component with a machine learning model to predict a remaining operating life for the at least one component; and
determine an operating status of the at least one component based on the remaining operating life predicted.

19. The system of claim 18, wherein the noise generated by the at least one component captured by the sound data includes sound waves in an ultrasonic frequency range.

20. The system of claim 19, wherein the machine learning model is trained with a machine learning algorithm on at least one training dataset, the at least one training dataset includes a collection of sample sound signatures for each of a plurality of sample components and the at least one training dataset includes a service history for each of the plurality of sample components associated with a time when the sample sound signature was obtained for each of the plurality of sample components.
